(19) United States
(12) Patent Application Publication
(10) Pub. No.: US 2023/0165221 A1
(43) Pub. Date: Jun. 1, 2023

(54) SMART TAG SYSTEM FOR LIVESTOCK

(71) Applicant: Farrpro, Inc., Iowa City, IA (US)

(72) Inventors: Amos Isaac Petersen, Iowa City, IA (US); Steven James Hoff, Iowa City, IA (US); Benjamin Carl Smith, Iowa City, IA (US); Cameron Jesse Smith, Iowa City, IA (US); James Donald Riley, Iowa City, IA (US)

(21) Appl. No.: 18/060,038

(22) Filed: Nov. 30, 2022

Related U.S. Application Data
(60) Provisional application No. 63/284,864, filed on Dec. 1, 2021.
(60) Provisional application No. 63/405,178, filed on Sep. 9, 2022.

(51) Int. Cl. A01K 29/00

(52) U.S. Cl. CPC A01K 29/005

(57) ABSTRACT

In one or more arrangements, a tag system for monitoring of livestock is presented. The system includes at least one tag and a control system communicatively connected to the tag. In one or more arrangements, the tag includes a housing and a connector configured to operably connect with the housing to facilitate attachment of the tag to an animal. The tag also includes a set of sensors. In one or more arrangements, the set of sensors includes a first temperature sensor configured to monitor a temperature of the animal (animal reference temperature), a second temperature sensor configured to monitor an ambient temperature (ambient reference temperature) of the environment where the animal is located, a gyroscopic sensor, and/or an accelerometer sensor. In one or more arrangements, the tag includes an electronic circuit positioned within the housing and configured to communicate data from the set of sensors to the control system.

### RELATED APPLICATIONS

This utility patent application claims priority to U.S. Provisional Patent Application No. 63/405,178, filed Sep. 9, 2022 and titled “SMART TAG SYSTEM FOR LIVESTOCK”, and also claims priority to U.S. Provisional Patent Application No. 63/284,864, filed Dec. 1, 2021 and titled “SMART TAG SYSTEM FOR LIVESTOCK”, each of which is hereby fully incorporated by reference herein.

### FIELD OF THE DISCLOSURE

This disclosure relates generally to monitoring systems. More specifically, and without limitation, this disclosure relates generally to systems for monitoring livestock.

### Overview of the Disclosure:

There are many challenges in maintaining healthy animals in livestock production. A variety of health conditions may arise in an animal population such as dehydration, illness, heat stroke, freezing, which can lead to mortality or poor growth rate. Current methods to monitor livestock include visual inspection or video surveillance of animals.

However, visually identifying and manually picking out individual animals in crowded pens is a time-consuming and ineffective method for identifying and diagnosing animals. Some other methods for monitoring livestock ping passive RFID identification tags and attempt to triangulate position of livestock based on differences in times that identification information transmitted by the tags is received by strategically positioned receiver circuits. However, it can be difficult to accurately monitor position of a large number of RFID tags using this method and monitoring location provides limited insight into health of livestock. Environmental controls and other automated system may be utilized in an animal enclosure to minimize health problems for animals housed in the enclosure, however, environmental conditions must also be frequently monitored to ensure that equipment failures are quickly addressed.

Therefore, for all the reasons stated above, and the reasons stated below, there is a need in the art for a livestock monitoring system that improves upon the state of the art. Thus, it is a primary object of the disclosure to provide a livestock monitoring system that improves upon the state of the art.

Another object of the disclosure is to provide a tag system for monitoring of livestock.

Yet another object of the disclosure is to provide a tag system having sensors for monitoring of livestock.

Another object of the disclosure is to provide a tag system for monitoring of livestock that includes a tag configured to communicate sensor data to a control system.

Yet another object of the disclosure is to provide a tag system for monitoring of livestock that performs analytics on data gathered by sensors in a tag.

Another object of the disclosure is to provide a tag system for monitoring of livestock that is less susceptible to damage.

Yet another object of the disclosure is to provide a tag system for monitoring of livestock that is easy to attach tags to livestock.

Another object of the disclosure is to provide a tag system for monitoring of livestock that can be reused for multiple animals.

Yet another object of the disclosure is to provide a tag system for monitoring of livestock that is durable.

Another object of the disclosure is to provide a tag system for monitoring of livestock that has a robust design.

Yet another object of the disclosure is to provide a tag system for monitoring of livestock that is easy to use.

Another object of the disclosure is to provide a tag system for monitoring of livestock that is high quality.

These and other objects, features, or advantages of the disclosure will become apparent from the specification, figures and claims.

### SUMMARY OF THE DISCLOSURE

In one or more arrangements, a tag system for monitoring of livestock is presented. The system includes at least one tag and a control system communicatively connected to the tag. In one or more arrangements, the tag includes a housing and a connector configured to operably connect with the housing to facilitate attachment of the tag to an animal. The tag also includes a set of sensors. In one or more arrangements, the set of sensors includes a first temperature sensor configured to monitor a temperature of the animal (animal reference temperature), a second temperature sensor configured to monitor an ambient temperature (ambient reference temperature) of the environment where the animal is located, a gyroscopic sensor, and an accelerometer sensor. In one or more arrangements, the tag includes an electronic circuit positioned within the housing and configured to communicate data from the set of sensors to the control system.

In one or more arrangements, the control system is configured to perform analytics on the data received from the electronic circuit of the tag to determine when the animal is engaging in one or more activities (e.g., lying prone, kneeling, standing, eating, drinking, walking, and sleeping). In one or more arrangements, the control system is configured to identify deviations in biometric data indicated by the data received from the electronic circuit of the tag. In one or more arrangements, the control system is configured to identify deviations in the data received from the electronic circuit of the tag from data previously received from the electronic circuit of the tag. In one or more arrangements, the control system is configured to identify deviations in the data received from the electronic circuit of the tag of the animal in comparison to data received from a plurality of tags attached to a plurality of other animals. In one or more arrangements, the control system is configured to perform one or more actions specified in a data file in response to the data received from the electronic circuit of the tag satisfying a trigger condition specified in the data file.

### BRIEF DESCRIPTION OF THE DRAWINGS

FIG. 1 shows a diagram of a tag system for monitoring of livestock, in accordance with one or more arrangements.

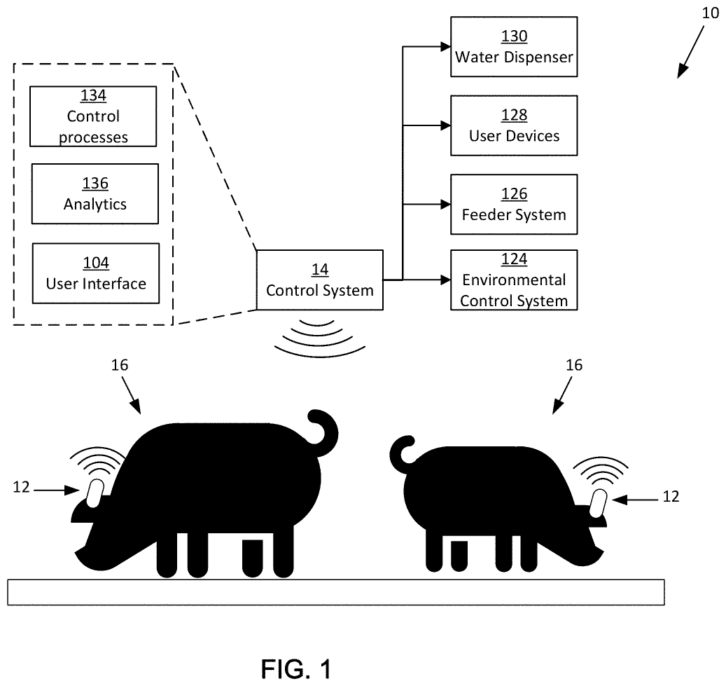

FIG. 2 shows a tag of a tag system for monitoring of livestock, in accordance with one or more arrangements; the view showing the tag attached to the ear of an animal.

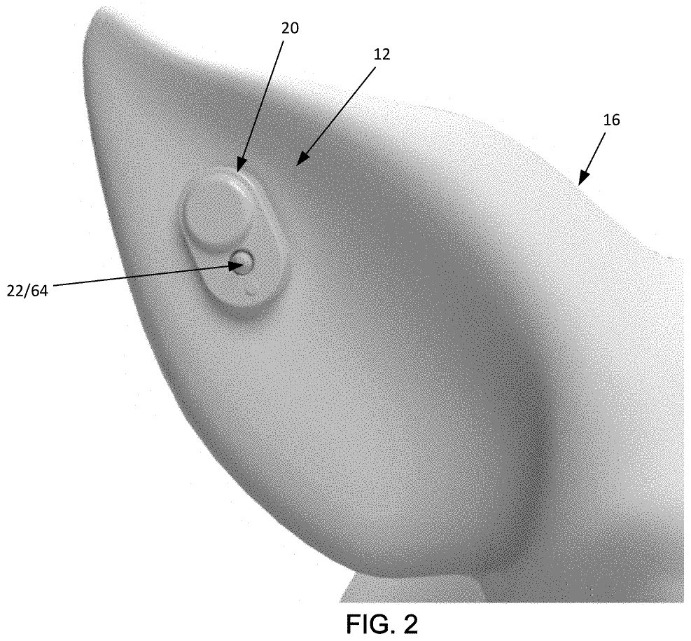

FIG. 3 shows a lower front left perspective view of tag of a tag system for monitoring of livestock, in accordance with one or more arrangements.

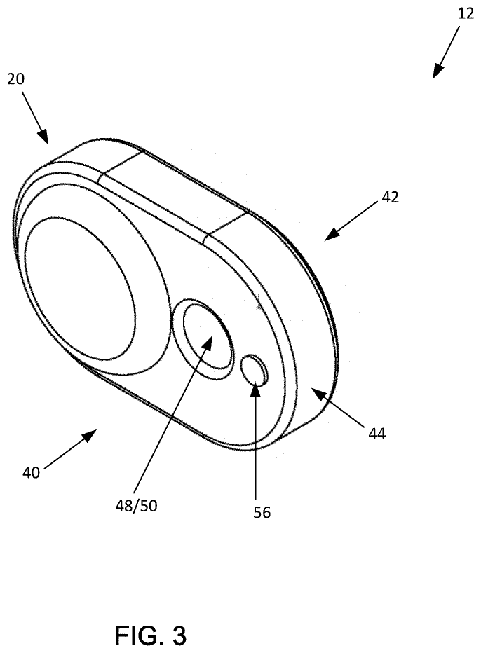

FIG. 4 shows an upper rear perspective view of tag of a tag system for monitoring of livestock, in accordance with one or more arrangements.

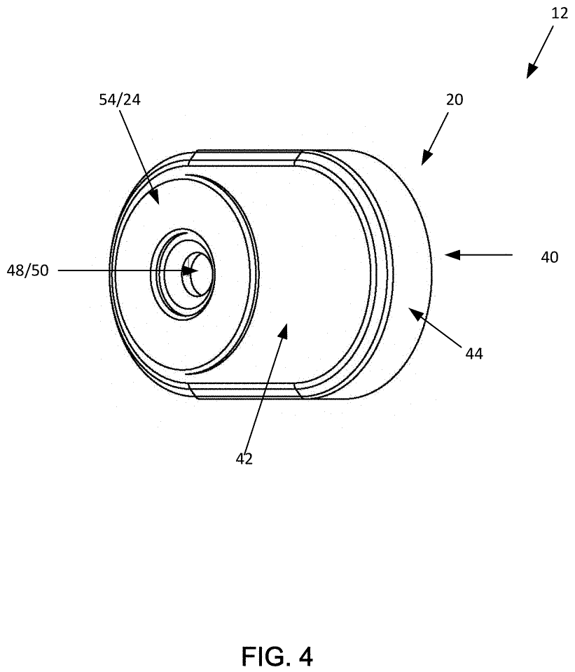

FIG. 5 shows a rear view of tag of a tag system for monitoring of livestock, in accordance with one or more arrangements.

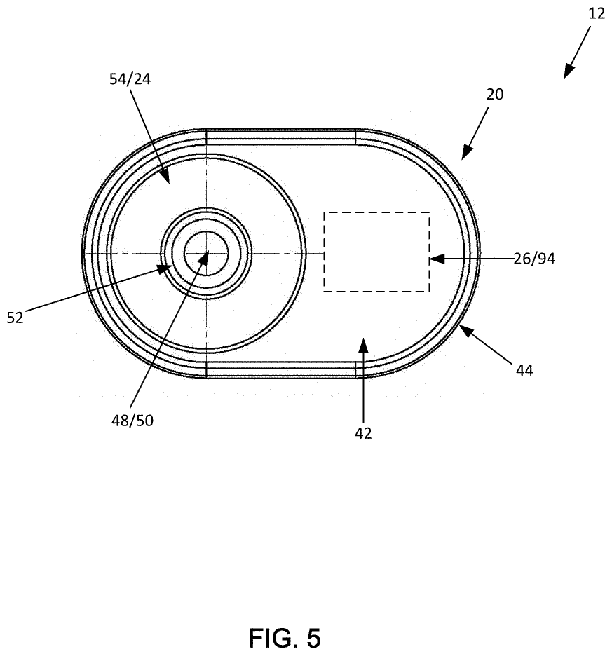

FIG. 6 shows a bottom view of tag of a tag system for monitoring of livestock, in accordance with one or more arrangements.

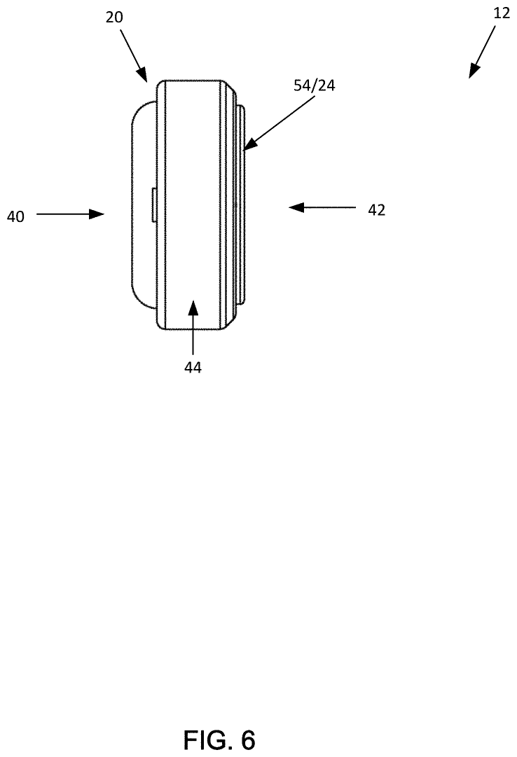

FIG. 7 shows a lower front left perspective view of tag of a tag system for monitoring of livestock, in accordance with one or more arrangements.

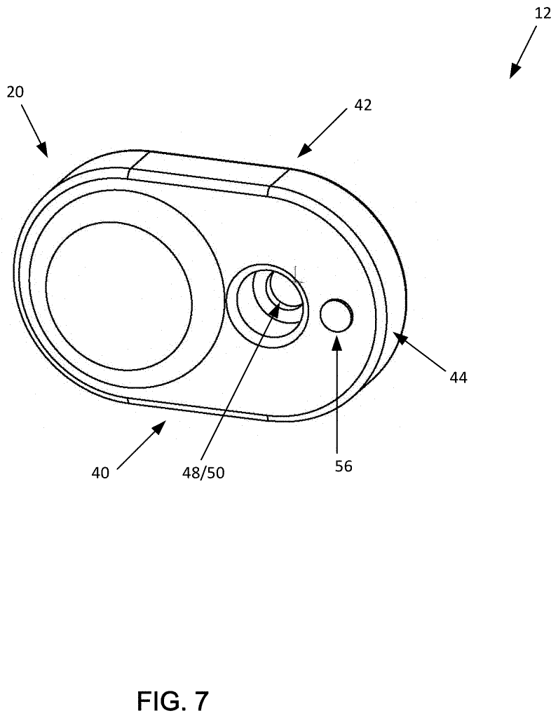

FIG. 8 shows a front view of tag of a tag system for monitoring of livestock, in accordance with one or more arrangements.

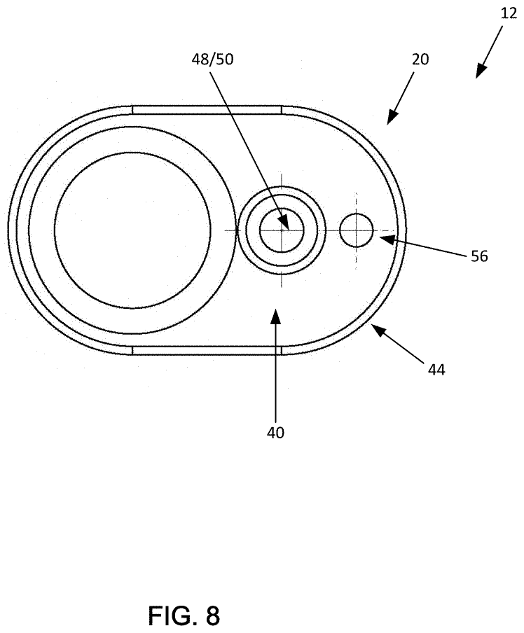

FIG. 9 shows a left side view of tag of a tag system for monitoring of livestock, in accordance with one or more arrangements.

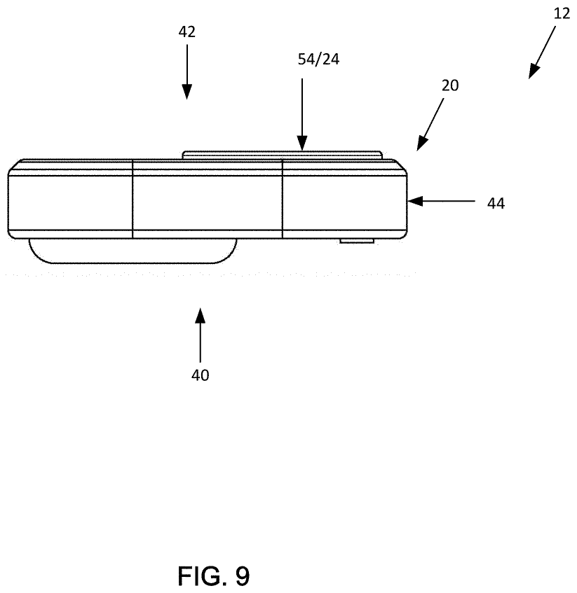

FIG. 10 shows a right side view of tag of a tag system for monitoring of livestock, in accordance with one or more arrangements.

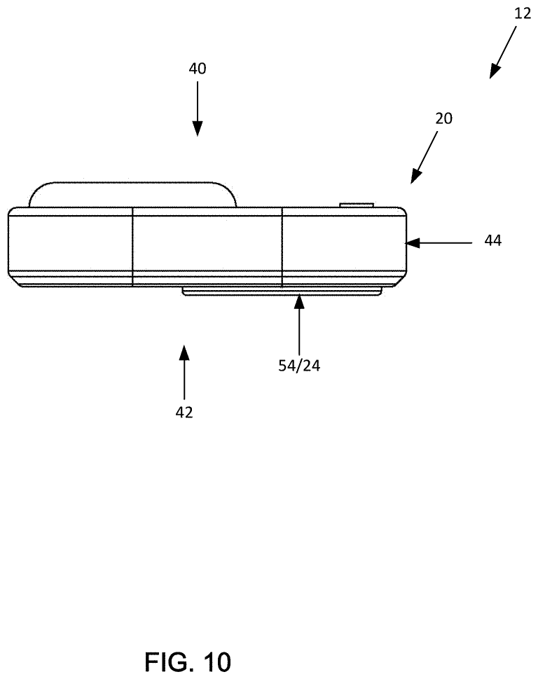

FIG. 11 shows a top view of tag of a tag system for monitoring of livestock, in accordance with one or more arrangements.

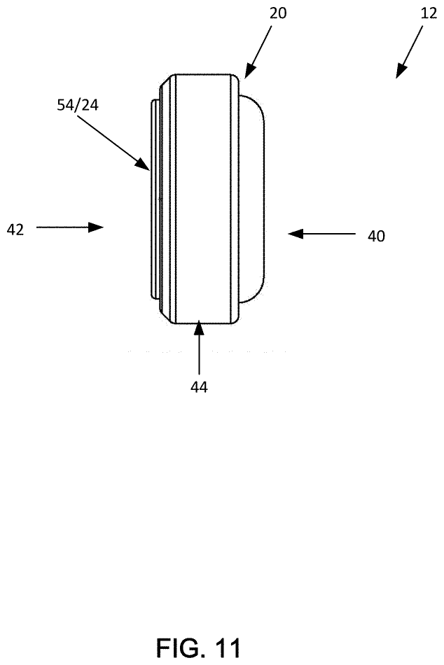

FIG. 12 shows a rear left perspective view of tag of a tag system for monitoring of livestock, in accordance with one or more arrangements.

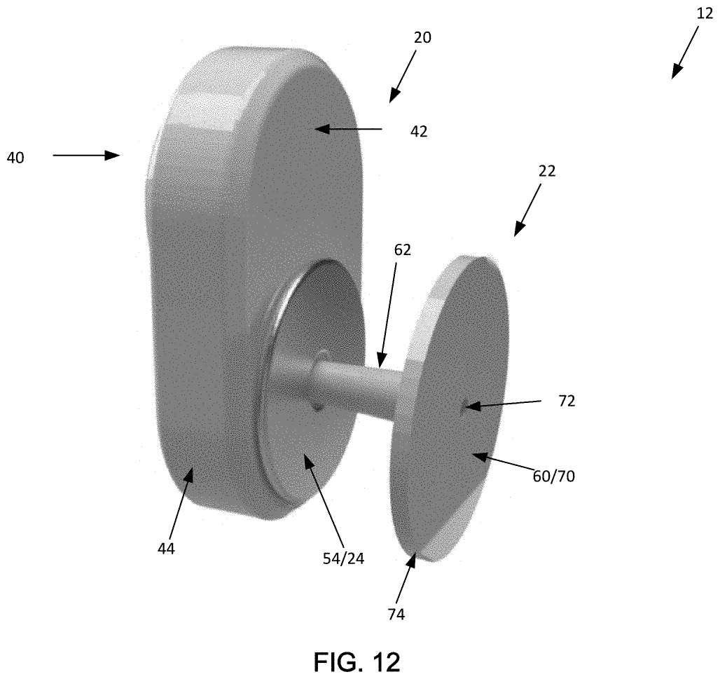

FIG. 13 shows a front view of tag of a tag system for monitoring of livestock, in accordance with one or more arrangements; the view showing the tag with a connector attached.

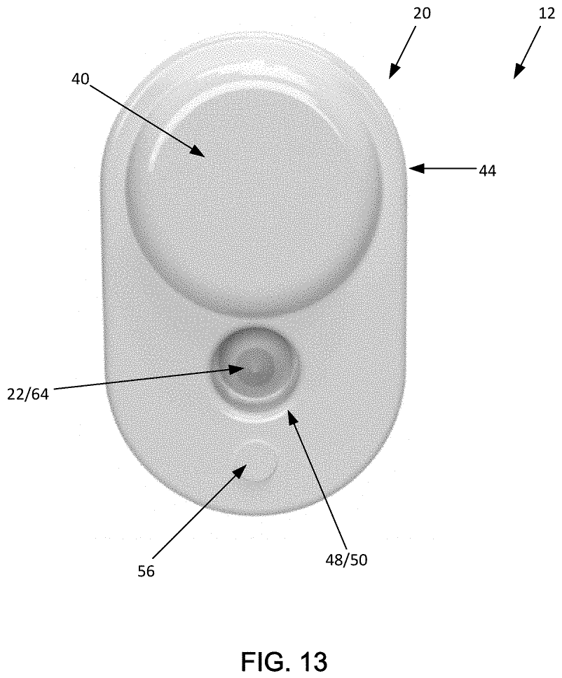

FIG. 14 shows a front view of tag of a tag system for monitoring of livestock, in accordance with one or more arrangements; the view showing the tag without a connector attached.

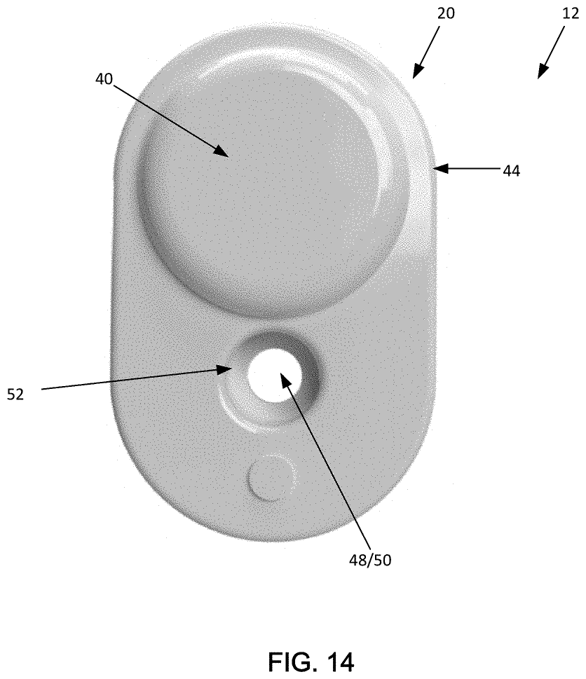

FIG. 15 shows a rear view of tag of a tag system for monitoring of livestock, in accordance with one or more arrangements; the view showing the tag without a connector attached.

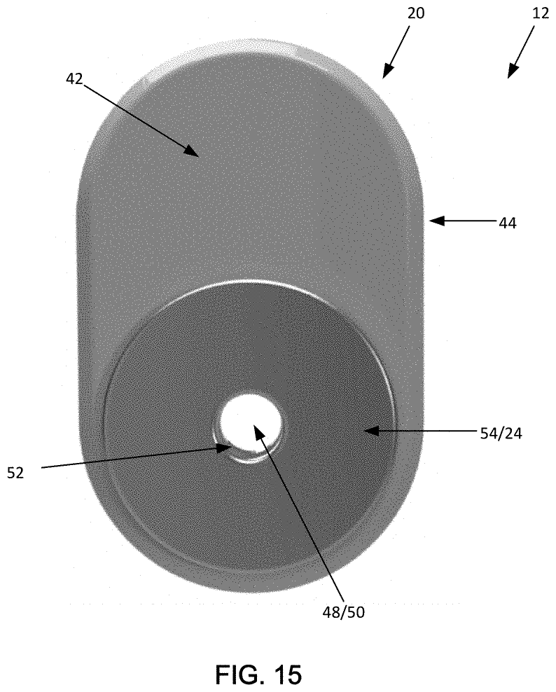

FIG. 16 shows a lower front view of connect for a tag of a tag system for monitoring of livestock, in accordance with one or more arrangements.

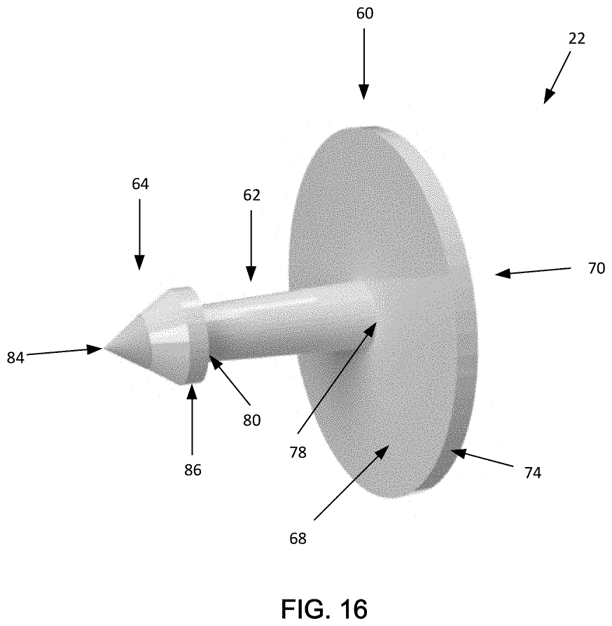

FIG. 17 shows a front left perspective view of a tag and a connector of a tag system for monitoring of livestock, in accordance with one or more arrangements.

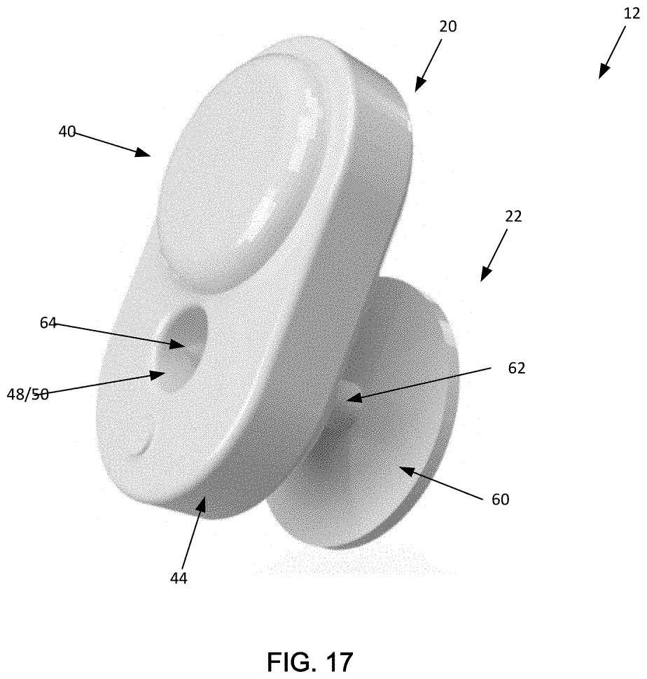

FIG. 18 shows a right side view of a tag and a connector of a tag system for monitoring of livestock, in accordance with one or more arrangements.

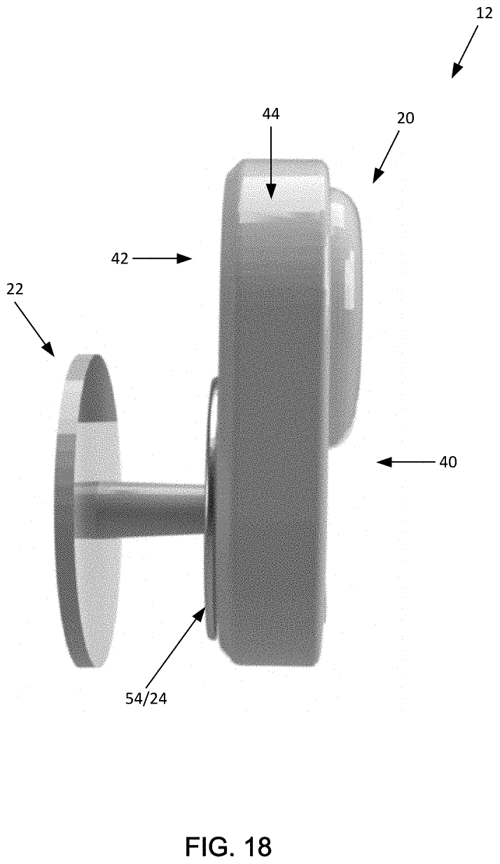

FIG. 19 shows an upper rear left perspective view of a tag and a connector of a tag system for monitoring of livestock, in accordance with one or more arrangements; the view showing the connector disconnected from the tag.

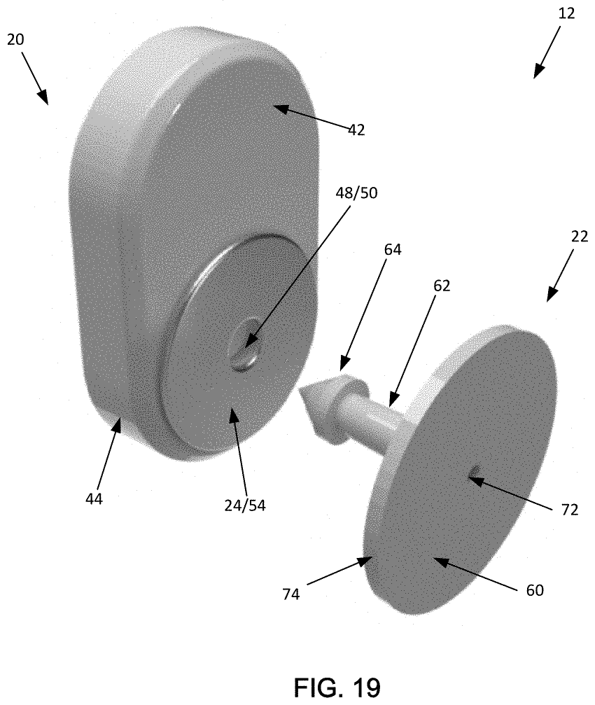

FIG. 20 shows a front left perspective view of a tag and a connector of a tag system for monitoring of livestock, in accordance with one or more arrangements; the view showing the connector disconnected from the tag.

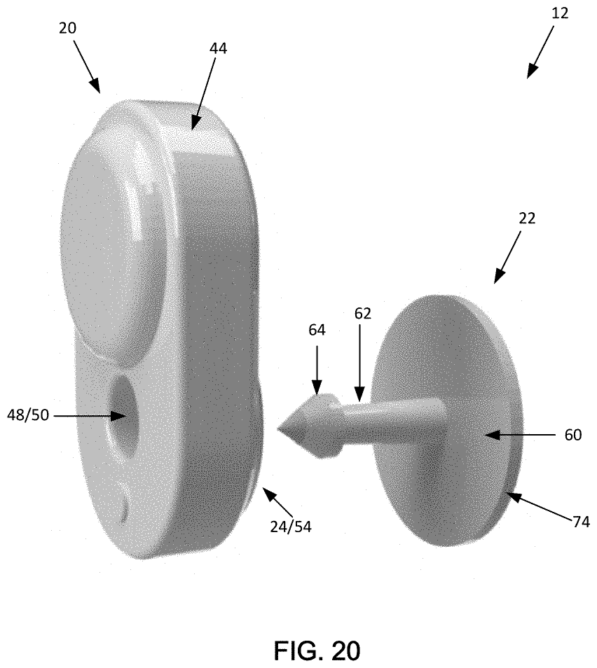

FIG. 21 shows diagram of a control system for use in a tag system for monitoring of livestock, in accordance with one or more arrangements.

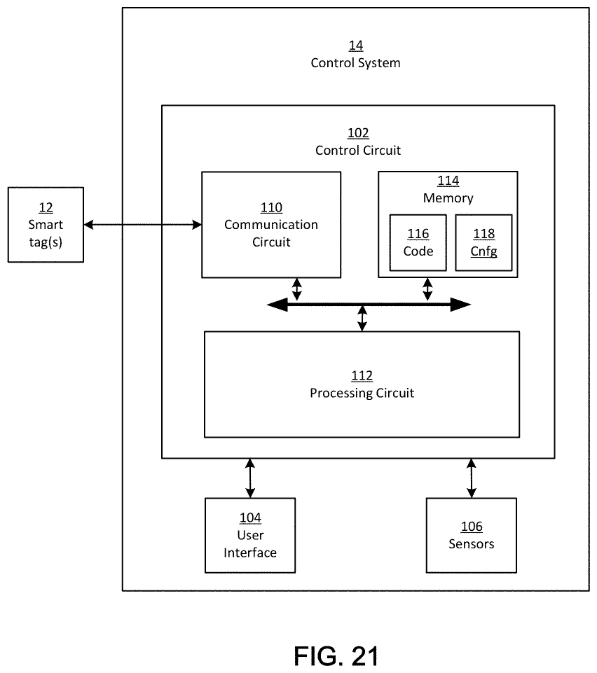

FIG. 22 shows a tag system for monitoring of livestock, in accordance with one or more arrangements; the view showing a plurality of tag connected with the system over a network.

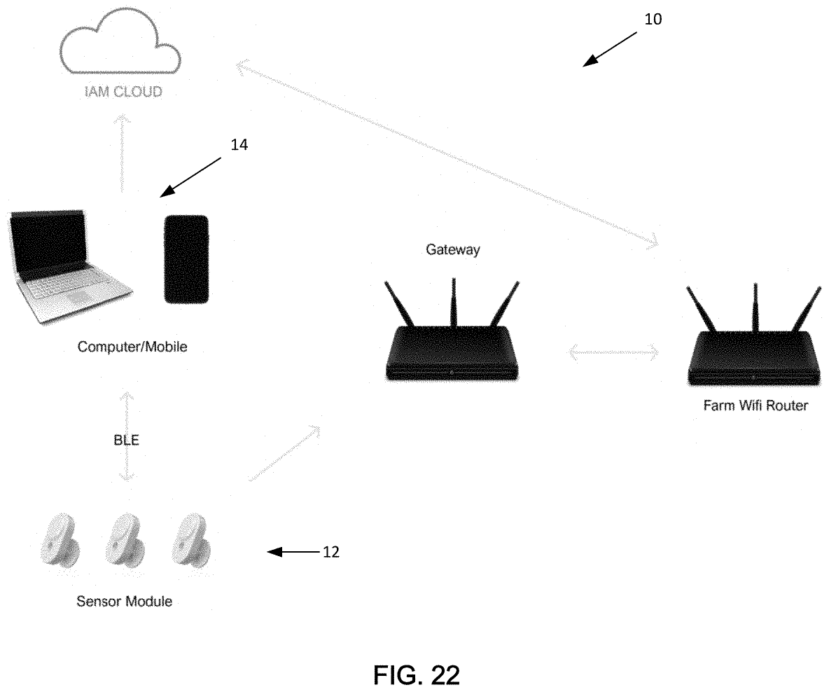

FIG. 23 shows a screen shot of a user interface for monitoring sensor readings of livestock monitored with a tag system in accordance with one or more arrangements; the view showing a summary of status information for a selected location.

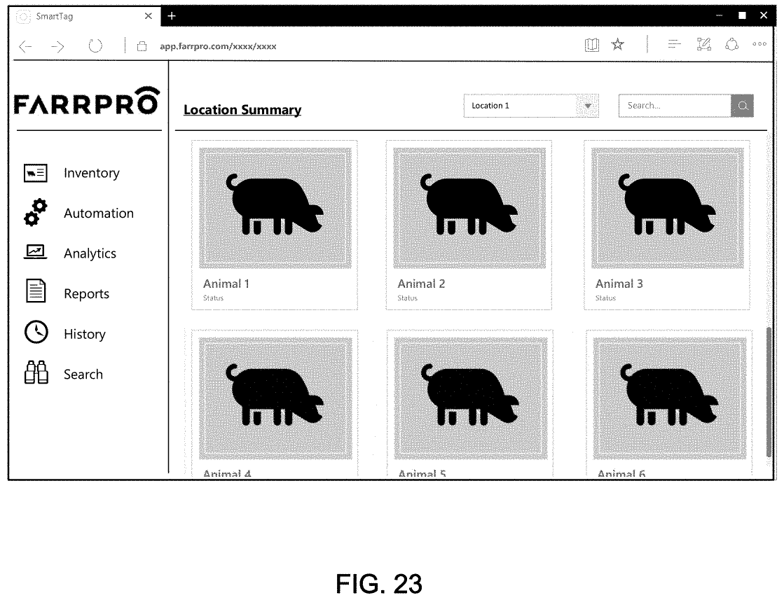

FIG. 24 shows a screen shot of a user interface for monitoring sensor readings of livestock monitored with a tag system in accordance with one or more arrangements; the view showing a summary of status information for a selected location; the view showing a sub-interface for input of information for a selected animal.

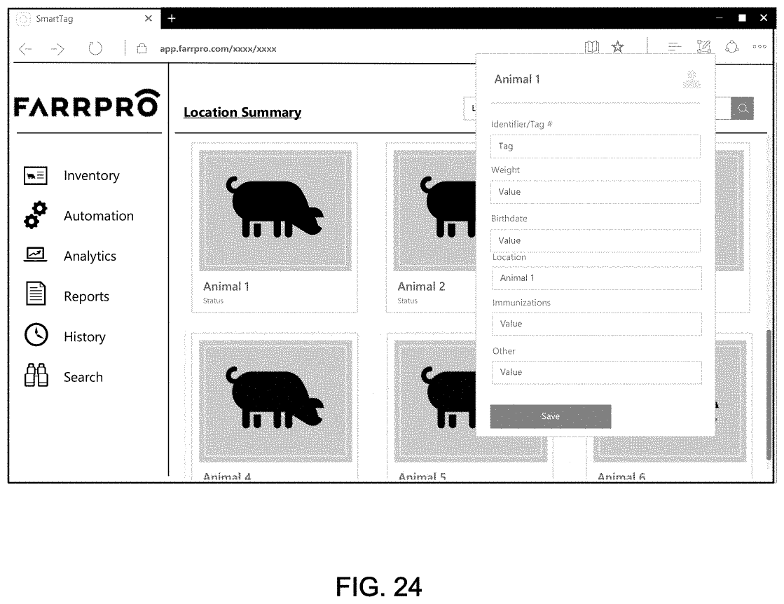

FIG. 25 shows a screen shot of a user interface for monitoring sensor readings of livestock monitored with a tag system in accordance with one or more arrangements; the view showing a history of selected sensor data for a selected animal; the view showing programed thresholds for which the system is configured to perform various actions in response to a value of the sensor data exceeding and/or falling below the particular thresholds.

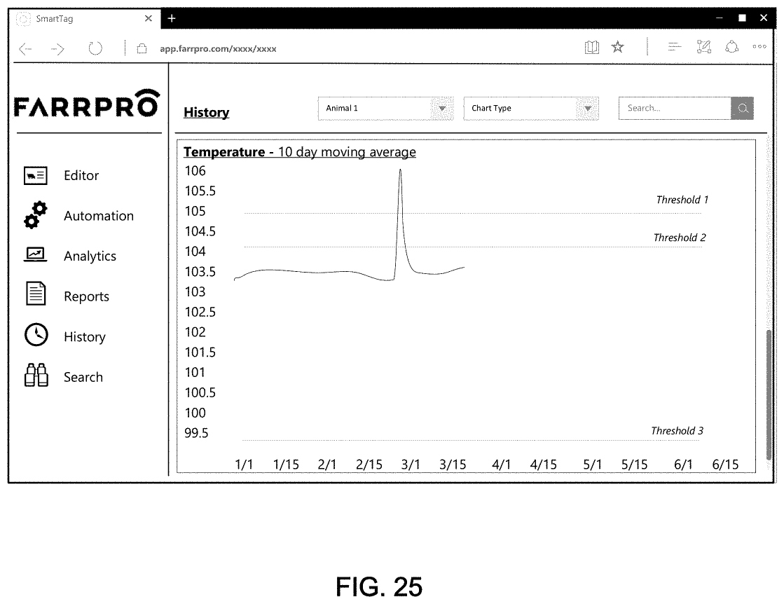

FIG. 26 shows a screen shot of a user interface for monitoring sensor readings of livestock monitored with a tag system in accordance with one or more arrangements; the view showing a summary of sensed activity for a selected animal(s); the view showing a bar graph display with proportional amounts of time for each day that an animal was determined to be engaged in a set of activities; the activities in this example including prone, standing, walking, eating, drinking, and other.

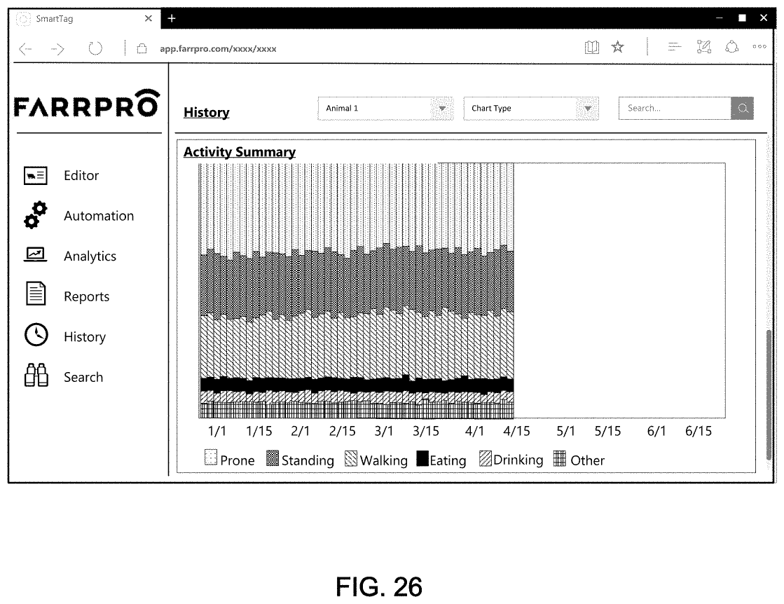

FIG. 27 shows a screen shot of a user interface for configuring automation performed by the system in response to sensor readings of livestock monitored with a tag system in accordance with one or more arrangements; the view showing interfaces for adjustment of heater control, water, feeder, airflow, lighting, and alerts in response to sensor readings.

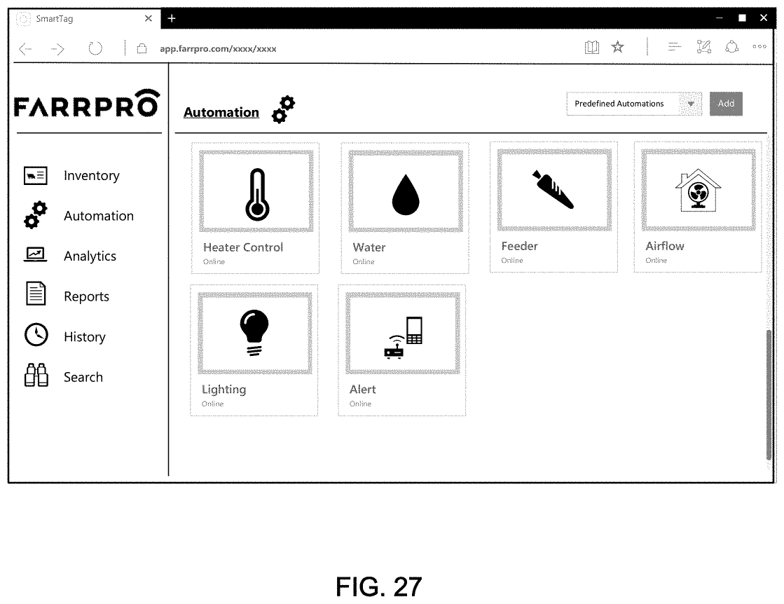

FIG. 28 shows a screen shot of a user interface for configuring automation performed by the system in response to sensor readings of livestock monitored with a tag system in accordance with one or more arrangements; the view showing a sub-interface for setting and/or adjusting values of a selected interface for automated control.

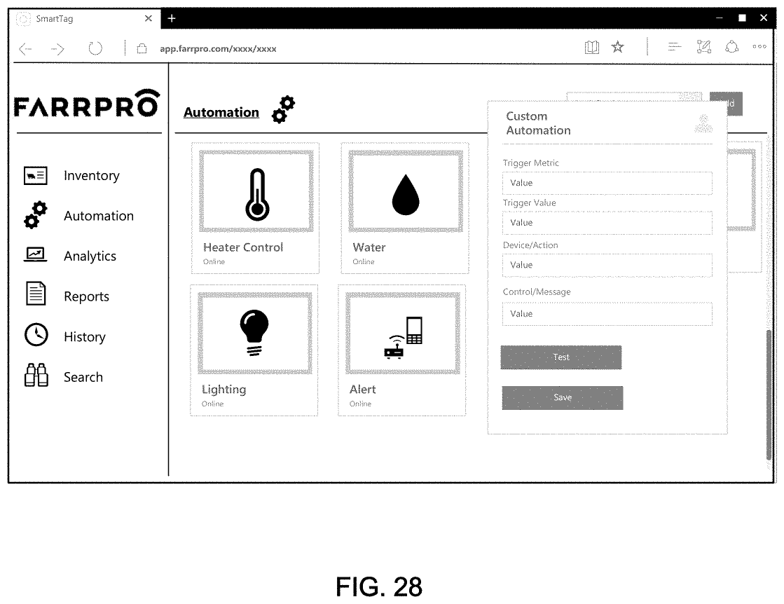

FIG. 29 shows a diagram of a livestock stall including a plurality of animals monitored by tags of a tag system for monitoring of livestock, in accordance with one or more arrangements; the view showing the stall having dispensing of water and feed controlled by the system in response to sensor readings provided by the tags.

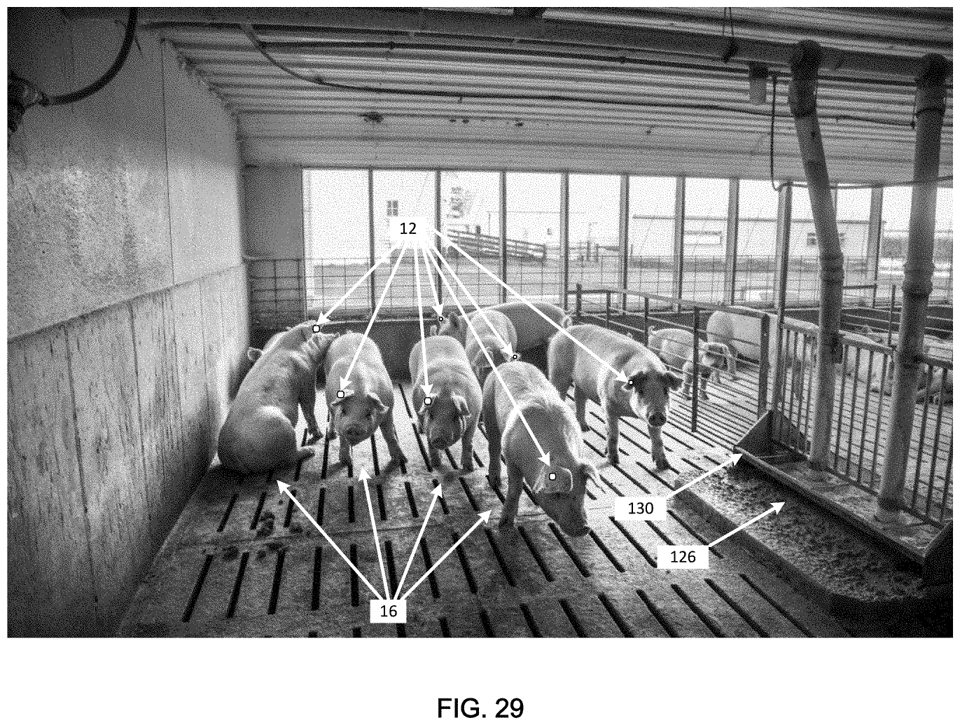

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

It should be understood that any advantages and/or improvements discussed herein may not be provided by various disclosed embodiments, and/or implementations thereof. The contemplated embodiments are not so limited and should not be interpreted as being restricted to embodiments that provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments that address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure. Moreover, although some disclosed embodiments may be described in the context of farming, the embodiments are not so limited. In is appreciated that the embodiments may be adapted for use in other applications which may be improved by the disclosed structures, arrangements and/or methods.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.). Similarly, a term such as “communicatively connected” includes all variations of information exchange and routing between two electronic devices, including intermediary devices, networks, etc., connected wirelessly or not.

It will be understood that, although the ordinal terms “first,” “second,” etc. may be used herein to describe various elements, these elements should not be limited to any order by these terms. These terms are used only to distinguish one element from another; where there are “second” or higher ordinals, there merely must be that many number of elements, without necessarily any difference or other relationship. For example, a first element could be termed a second element, and, similarly, a second element could be termed a first element, without departing from the scope of example embodiments and/or methods.

Similarly, the structures and operations discussed below may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of monitoring livestock. However, the embodiments are not so limited. It is appreciated that the embodiments may be adapted for use in various other applications, which may be improved by the disclosed structures, arrangements and/or methods. The system is merely shown and described as being used in the context of monitoring livestock for ease of description and as one of countless examples.

### System 10:

In various embodiments, a smart tag system for monitoring of livestock 10 (or simply system 10) may be formed of any suitable size, shape, and design and is configured to gather data related to the care of livestock using a smart tag attached to the animal 16. In one or more arrangements, system 10 includes one or more smart tags 12 and a control system 14, among other components.

### Smart Tag 12:

Smart Tags 12 are formed of any suitable size, shape and design and are configured to record data related to the care of livestock animals 16 to which smart tags 12 are attached. In one or more arrangements, recorded data may include, for example, reference temperature of the animals 16 (animal reference temperature), reference temperature of the ambient environment (ambient reference temperature), gyroscopic motion, acceleration, sound, light, galvanic response, respiratory rate, heart rate, location, and/or any other information related to the care of livestock. In the arrangement shown, as one example, smart tag 12 includes a housing 20, a connector 22, one or more sensors 24, an electronic circuit 26, and a power source 28 among other components.

### Housing 20:

Housing 20 is formed of any suitable size, shape, and design and is configured to house various components of smart tag 12 and facilitate deployment and/or user operability. In the arrangement shown, as one example, housing 20 includes a front side 40, a back side 42, and an exterior peripheral edge 44, formed by sides of housing 20, which is generally square to the planes formed by the front and back sides 40/42 of smart tag 12. In the arrangement shown, as one example, when viewed from the front 40 or back 42, smart tag has a stadium shape, which may improve durability and inhibit other livestock chewing on the smart tag 12. However, the arrangements are not so limited. Rather, it is contemplated that in some various arrangements, smart tag 12 may have any shape. In the arrangement shown, front side 40, back side 42, and exterior peripheral edge 44 of housing 20 form a hollow interior 46 (not shown) configured to house the other components of smart tag 12. Alternatively, in one or more arrangements, housing 20 is formed of a solid structure molded around other components of smart tag 12.

It is recognized that livestock operations are extraordinarily difficult environments to operate electronic devices. In such operations, electronic devices may be subjected to wide temperature ranges, all types of outdoor weather conditions of all types, pressing under large amounts of weight, chewing by animals 16, and/or exposure to bio wastes among other environmental conditions. In one or more arrangements, housing 20 may include waterproofing and/or other features to facilitate protection of sensors 24, electronic circuit 26 and/or other components of smart tag 12.

In one or more arrangements, housing 20 includes a portion formed of a rigid durable material (e.g., PETG) that is configured to protect electronic circuit 26, sensors 24, and/or other sensitive components of smart tag 12. In one or more arrangements, housing 20 provides a waterproof seal to prevent water and/or bio wastes from contacting electronic circuit 26, sensors 24, and/or other sensitive components of smart tag 12. In one or more arrangements, housing 20 has slopped surfaces and/or edges to help prevent animals 16 from chewing on the smart tag 12. For example, in the arrangement shown, housing 20 has an elongated oval shaped front side 40 and back side 42 with curved peripheral edge 44.

### Connection Feature 48:

In one or more arrangements, housing 20 includes a connection feature 48. Connection feature 48 is formed of any suitable size, shape, and design and is configured to operably connect with connector 22 to facilitate attachment of smart tag 12 with an animal 16. In the arrangement shown, connection feature 48 is an opening 50 extending through housing 20 and is configured to receive and connect with a male pin type connector 22. In this example arrangement, opening 50 has a smaller diameter than a head 64 of the male pin type connector 22.

In this example arrangement, a flexible portion 52 of housing 20 proximate to opening is formed of a material configured to flex and expand to permit head 64 of connector 22 to be pushed though opening 50 to facilitate connection with connector 22. Once head 64 is pushed though opening 50, opening 50 contracts to hold and prevent connector 22 from being removed from opening. In this manner, connector 22 is semi-permanently connected with housing 20.

Through careful observation and experimentation, it has been surprisingly discovered that thermoplastic polyurethane (TPU) or other material having a durometer value in the range of approximately A90-A95 ideally permits the material to flex to permit head 64 of connector 22 to be pushed though opening 50 but is rigid enough to prevent head 64 of connector 22 from being unintentionally removed from opening 50. In one or more arrangements, housing 20 may be formed of multiple different types of materials to provide flexibility in some areas (e.g., portion 52 proximate to opening 50) and structural rigidity in other areas. For example, in one or more arrangements, housing 20 includes a portion formed of a rigid material (e.g., Pet G) that is configured to protect electronic circuit 26, sensors 24, and/or other sensitive components of smart tag 12.

While some arrangements may be described or shown with reference to a male type connector 22 and a female type connection feature 48, the embodiments are not so limited. Rather it is contemplated that in some various arrangements, housing 20 may conversely include a male type connection feature 48 configured to connect with a female connection feature of connector 22. Moreover, the embodiments are not so limited to the use of male/female type connectors. Rather, it is contemplated that in some various arrangements, housing 20 and connector 22 may be configured to connect with each other and/or connect smart tag 12 with an animal 16 using various methods and means known in the art for connecting tags with animals 16.

### Sensor Contact Area 54:

In one or more arrangements, housing may have a sensor contact area 54 formed on a surface (e.g., on back side 42) of the housing 20. Sensor contact area 54 is formed of any suitable size, shape, and design, and is configured to facilitate contact of a sensor 24 with the animal 16 to which smart tag 12 is connected. In this example arrangement, sensor contact area 54 has a generally circular shape extending around opening 50 of connection feature 48.

Having sensor contact area 54 extend around opening 50 may help a sensor 24 maintain connection with a preferred location of the animal 16 as smart tag 12 is rotated (e.g., by the animal 16) during operation. In the arrangement shown, sensor contract area 54 is raised or extends outward from the exterior surface of back side 42 to help maintain physical contact between sensor contact area 54 and the animal 16.

However, the embodiments are not so limited. Rather, it is contemplated that in one or more arrangements, sensor contract area 54 may be flush with housing 20. Moreover, it is contemplated that housing 20 may additionally or alternatively include one or more sensor contacts areas 54 of various other shapes and/or at various other locations on smart tag 12. For example, in one or more arrangements, in which housing 20 has a male type connection feature 48 configured to connect with a female connection feature of connector 22, smart tag 12 may include a sensor contacts area 54 positioned on the male type connection feature 48. In such arrangement, when the connection feature 48 is pierced through an ear of an animal 16, for example, to attach the smart tag 12 to the animal 16, the sensor contacts area 54 extends through the piercing. In this manner, the sensor contacts area 54 is always in contact with the animal 16.

Indicator 56:

In one or more arrangements, smart tag 12 has an indicator positioned on housing 20. Indicator is formed of any suitable size, shape, design, technology, and in any arrangement and is configured to provide a visual display of information and/or notification. In one or more arrangements, such visual display may include, for example, LED lights, meters, gauges, screen, monitor or any other type of visual indicator.

As an illustrative example, in one or more arrangements, control system 14 may utilize an LED positioned on housing 20 to provide visual indications. Such visual indication may be useful to alert an animal caretaker that animal 16 may need attention. Additionally or alternatively, in one or more arrangements, the indicator 56 on housing may be useful to help an animal caretaker locate a particular animal 16 in a barn or pen. For example, in one or more arrangement, the animal caretaker may prompt control system 14 and/or smart tag 12 to light an LED type indicator 56 on the smart tag 12 of a particular animal 16 by selecting the animal 16 via user interface 104. In one or more arrangements, housing 20 is formed of a transparent material so light from LED type indicator 56 may be visible through the housing 20 from a greater range of viewpoints. Additionally or alternatively, in one or more arrangements, an LED type indicator 56 on the smart tag 12 may be configured to read out information. For example, in one or more arrangements, an LED type indicator 56 on the smart tag 12 may be configured to read out information in a blink code format. Additionally or alternatively, in one or more arrangements, an LED type indicator 56 may be configured to transmit data to control system 14 (or other devices), for example, using IR communication. LED type indicator 56 may be any other form of an indicator, such as a visual indicator, such as a light, an audible indicator such as a speaker or other sound generating device, a physical indicator, such as a vibrating member, or any other type of indicator or combination thereof

### Connector 22:

Connector 22 is formed of any suitable size, shape, and design and is configured to facilitate connection of smart tag 12 to an animal 16. In the arrangement shown, connector 22 is configured to connect smart tag 12 to an ear of an animal 16 by piercing to operate smart tag 12 as an ear tag. In the arrangement shown, as one example, connector 22 is male pin type connector having a backing 60, a pin 62, and a head 64. In this example arrangement, connector 22 is configured to pierce through an ear (or other body part) and connect with housing 20 to attach smart tag 12 to the animal 16. However, the embodiments are not so limited. Rather, it is contemplated that in some various arrangements, smart tag 12 may be connected with animals 16 using various different methods and means including but not limited to, for example, piercing, bands, collars, injections, implantation, and/or any other means or method for attaching tags to animals 16.

### Backing 60

Backing 60 is formed of any suitable size, shape, and design, and is configured to connect with a rear end 78 of pin 62 and provide a surface to contact the ear of the animal 16 and prevent pin 62 from being disconnected from an animal 16 after smart tag 12 is connected.

In the arrangement shown, as one example, backing 60 has a generally circular disc shape having a generally planar front surface 68 and rear surface 70 extending outward from a center point 72 to an exterior edge 74. However, the embodiments are not so limited. Rather, it is contemplated that backing 60 may be any shape.

### Pin 62

Pin 62 is formed of any suitable size, shape, and design, and is configured to facilitate connection between backing 60 and head 64 through a piercing of the animal 16 for attachment of connector 22 with housing 20. In the arrangement shown, as one example, pin 62 has a generally cylindrical shape extending between a rear end 78 connected to center point 72 of backing 60 and a front end 80 connected to head 64.

### Head 64

Head 64 is formed of any suitable size, shape, and design, and is configured to facilitate piercing of head 64 and pin 62 through an ear (or other part) of the animal 16, facilitate insertion of head 64 into and connection of head 64 with connection feature 48 of housing 20. In the arrangement shown, head 64 has generally conical shape extending outward from a front tip 84 to a rear base 86.

In this example arrangement, front tip 84 and conical shape of head 64 aids in piercing through the ear and insertion of head 64 into and through opening 50 of connection feature 48 of housing 20. In this example arrangement, rear base 86 of head 64 is wider than opening 50 of connection feature 48. In this example arrangement, the portion 52 of housing 20 proximate to opening 50 is formed of a flexible material that permits opening 50 to stretch or dilate as head 64 is pushed through opening 50. Once rear base 86 is pushed through opening, the flexible material of opening 50 contracts around pin 62. In this example arrangement, rear base 86 of head 64 has a blunt rear surface to inhibit head 64 from being pulled back through opening 50. In this manner, connector 22 is connected to connection feature 48 of housing 20.

### Example Tagging Operation:

As an illustrative example, smart tag 12 may be connected to the ear of an animal 16 via piercing using an appropriate tag applicator 90 (not shown). The tag applicator 90 is configured to receive, hold, and position housing 20 and connector 22 on opposing sides of the animal's 16 ear with head 64 and pin 62 aligned with opening 50 of connection feature 48 of housing 20. Most commonly, tag applicator 90 has an actuator configured to clamp housing 20 and connector 22 toward one another. As clamp housing 20 and connector 22, head 64 and pin 62 pierce through the animal's 16 ear and then are inserted into opening 50 of connection feature 48 of housing 20 to cause connector 22 to operably connect with housing 20. Once connector 22 and housing 20 are operably connected, tag applicator is disconnected from both connector 22 and housing 20. In this manner, smart tag 12 is semi-permanently attached to the animal 16.

When it is desired to remove smart tag from an animal 16, connector 22 and housing 20 may be disconnected by pressing connector 22 and housing 20 toward one another to cause pin 62 of connector to extend further through opening 50 until head 64 is exposed on the other side of housing 20. With head 64 exposed, head may be cut from pin 62 of connector 22 using, for example, a clipper, scissor, or other cutting device. With head 64 removed, pin 62 of connector 22 may be pulled rearward to remove pin 62 from opening 50 of connection feature 48 and thereby disconnect connector 22 from housing 20. With connector 22 disconnected from housing 20, pin 62 of connector 22 maybe be extracted from the piercing hole of the animal 16 to completely disconnect the smart tag 12 from the animal 16.

In one or more arrangements, smart tag 12 is configured to be reusable. For example, in one or more arrangements, power source 28 (not shown) of smart tag 12 is sufficient to operate smart tag 12 through multiple hog production cycles (e.g., farrow to wean, feeder pig or nursery, finishing, breeding stock, and farrow to finish). For example, in one or more arrangements, power source 28 of smart tag is sufficient to operate smart tag 12 through the consecutive production cycle of 3 hogs (approximately 5 months each). Once a smart tag 12 has been removed, the housing 20 side of smart tag 12 may be cleaned and connected with a new piglet using a new connector 22 as previously described. Additionally or alternatively, in one or more arrangements, housing 20 is configured to permit power source 28 to be replaced. Additionally or alternatively, in one or more arrangements, housing 20 is configured to permit power source 28 to be recharged (e.g., between production cycles. For instance, in one or more arrangements, power source 28 may be recharged via a wireless charger or a waterproof wired charging port.

### Sensors 24:

In one or more arrangements, smart tag 12 includes and/or is communicatively connected to one of more sensors 24. Sensors 24 are formed of any suitable size, shape, and design, and are configured to detect various data metrics pertaining to raising of livestock (e.g., biometric characteristics of the animal 16, environmental characteristics, characteristics of use, and/or any other data metrics.

Any number of sensors 24 are connected to, incorporated within, or used in association with smart tag 12. In one arrangement shown, as one example, smart tag 12 includes a plurality of sensors 24 positioned within hollow interior 46, on a surface of housing 20, and/or on another position of smart tag 12, the sensors including: a first temperature sensor configured to measure temperature of an animal 16, a second temperature sensor configured to measure ambient reference temperature of the environment, an accelerometer, and a gyroscope or tilt sensor. However, the embodiments are not so limited. Rather, it is contemplated that in one or more arrangements, a smart tag 12 may include various different types of sensors including but not limited to, for example, temperature sensors, gyroscopic or tilt sensors, accelerometers, position sensors, sound sensors, light sensors, humidity sensors, chemical sensors, other biometric sensors (e.g., heart rate sensors, blood pressure, glucose level sensors, hydration level sensors, heart rate sensors, breathing rate sensors, and/or any other biometric sensor), and/or any other sensor that provides information related to the status and/or care of livestock.

### Electronic Circuit 26:

Electronic circuit 26 is formed of any suitable size, shape, and design, and is configured to acquire data readings from sensors 24 and facilitate communication of the acquired data to a control system 14. In one or more arrangements, electronic circuit 26 includes a communication circuit 94. Communication circuit 94 is formed of any suitable size, shape, design, technology, and in any arrangement and is configured to facilitate communication with control system 14, a tag reader device, and/or other components of system 10. In one or more arrangements, as one example, communication circuit 94 includes a transmitter (for one-way communication) or transceiver (for two-way communication). In various arrangements, communication circuit 94 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network. In some various arrangements, electronic circuit 26 and/or communication circuit 96 may be configured communicate data from sensors 24 to control system 14 (or other device) continuously, periodically, according to a schedule, when prompted by control system 14 (or other device), and/or in response to any other stimuli or command.

### Power Source 28:

In the arrangement shown, as one example, smart tag 12 includes a power source 28. Power source 28 is formed of any suitable size, shape, design, technology, and in any arrangement or configuration and is configured to provide power to smart tag 12 so as to facilitate the operation of the electronic circuit 26, sensors 24, and/or other electrical components of the smart tag 12. In the arrangement shown, as one example, power source 28 is formed of one or more batteries, which may or may not be rechargeable. Additionally or alternatively, in one or more arrangements, power source 28 may include a solar cell or solar panel that may power or recharge smart tag 12. Additionally or alternatively, in one or more arrangements, power source 28 may be line-power that is power that is delivered from an external power source into the smart tag 12 through a wired connection. Additionally or alternatively, in one or more arrangements, power source 28 may be a wireless power delivery system configured to power or recharge smart tag 12. Any other form of a power source 28 is hereby contemplated for use.

### Switch 30:

In one or more arrangements, smart tag 12 includes a switch 30 (not shown). Switch 30 is formed of any suitable size shape, or design and is configured to enable a user to power on, power off, wake up, sleep, and/or otherwise control smart tag 12. In some various arrangements, switch 30 may be implemented using various types of commercially available switches. In one or more arrangements, switch 30 is a waterproof switch so as to prevent animal waste from entering housing 20. In one or more arrangements, switch 30 is a magnetic-type switch (e.g., a Hall-effect sensor), which permits a user to engage the switch 30 by briefly placing a magnet against housing 20. Use of a magnetic-type switch beneficially avoids the need to have any opening in housing 20 for the switch. In one or more arrangements, smart tags 12 ship in a deep sleep state to conserve power. When placed in use, a user engages switch 30 to wake up smart tag 12 and initiate communication between smart tags 12 and control system 14.

### Control System 14:

Control system 14 is formed of any suitable size, shape, design and is configured to receive sensor data from smart tags 12 and/or other sensors and process the received sensor data to facilitate monitoring, analytics and/or automated performance of various actions, for example, to assist in the care of livestock. In the arrangement shown, as one example, control system 14 includes a control circuit 102, user interface 104, and/or additional sensors 106, among other components.

### Control Circuit 102:

Control circuit 102 is formed of any suitable size, shape, design and is configured to receive and process data received from smart tags 12, data received from other 106, and/or input from user interface 104. In the arrangement shown, as one example, control circuit 102 includes a communication circuit 110, a processing circuit 112, and a memory 114 having software code 116 or instructions that facilitates the operation of system 10.

Processing circuit 112 may be any computing device that receives and processes information and outputs commands according to software code 116 stored in memory 114. For example, in some various arrangements, processing circuit 112 may be discreet logic circuits or programmable logic circuits configured for implementing these operations/activities, as shown in the figures and/or described in the specification. In certain arrangements, such a programmable circuit may include one or more programmable integrated circuits (e.g., field programmable gate arrays and/or programmable ICs). Additionally or alternatively, such a programmable circuit may include one or more processing circuits (e.g., a computer, microcontroller, system-on-chip, smart phone, server, and/or cloud computing resources). For instance, computer processing circuits may be programmed to execute a set (or sets) of software code stored in and accessible from memory 114. Memory 114 may be any form of information storage such as flash memory, ram memory, dram memory, a hard drive, or any other form of memory.

Processing circuit 112 and memory 114 may be formed of a single combined unit. Alternatively, processing circuit 112 and memory 114 may be formed of separate but electrically connected components. Alternatively, processing circuit 112 and memory 114 may each be formed of multiple separate but communicatively connected components. Software code 116 is any form of instructions or rules that direct how processing circuit 112 is to receive, interpret and respond to information to operate as described herein. Software code 116 or instructions are stored in memory 114 and accessible to processing circuit 112.

Communication circuit 110 is formed of any suitable size, shape, design, technology, and in any arrangement and is configured to facilitate communication with smart tags 12 and/or devices to be controlled and/or alerted by control system 14. In one or more arrangements, as one example, communication circuit 110 includes a transmitter (for one-way communication) or transceiver (for two-way communication). In various arrangements, communication circuit 110 may be configured to communicate with various components of system 10 using various wired and/or wireless communication technologies and protocols over various networks and/or mediums including but not limited to, for example, IsoBUS, Serial Data Interface 12 (SDI-12), UART, Serial Peripheral Interface, PCI/PCIe, Serial ATA, ARM Advanced Microcontroller Bus Architecture (AMBA), USB, Firewire, RFID, Near Field Communication (NFC), infrared and optical communication, 802.3/Ethernet, 802.11/WIFI, Wi-Max, Bluetooth, Bluetooth low energy, UltraWideband (UWB), 802.15.4/ZigBee, ZWave, GSM/EDGE, UMTS/HSPA+/HSDPA, CDMA, LTE, FM/VHF/UHF networks, and/or any other communication protocol, technology or network.

### Sensors 106:

Sensors 106 are formed of any suitable size, shape, design, technology, and in any arrangement configured to measure factors pertaining to operation of system 10 and/or monitoring and/or management of livestock. In some various arrangements, sensors 106 may include but are not limited to, for example, temperature sensors, voltage sensors, current sensors, location sensors (e.g., GPS sensors), position sensors, switches, motion sensors, speed sensors, proximity sensors, light sensors, cameras, microphones, LIDAR, speed sensors, humidity sensors, moisture sensors, fuel and/or energy sensors, and/or any other type of sensor, and/or various combinations thereof.

In some arrangements, sensors 106 may be formed along with control circuit 102 as a single combined unit. Alternatively, in some arrangements, sensors 106 and control circuit 102 may be communicatively connected by communication circuit 110.

### User Interface 104:

User interface 104 is formed of any suitable size, shape, design, technology, and in any arrangement and is configured to facilitate user monitoring, control, and/or adjustment of various components of system 10. In one or more arrangements, as one example, user interface 104 includes a set of inputs (not shown). Inputs are formed of any suitable size, shape, and design and are configured to facilitate user input of data and/or control commands. In various different arrangements, inputs may include various types of controls including but not limited to, for example, buttons, switches, dials, knobs, a keyboard, a mouse, a touch pad, a touchscreen, a joystick, a roller ball, or any other form of user input. Optionally, in one or more arrangements, user interface 104 includes a display (not shown). Display is formed of any suitable size, shape, design, technology, and in any arrangement and is configured to display information of settings, sensor readings, time elapsed, and/or other information pertaining to operation or system 10 and/or management of livestock. In one or more arrangements, display may include, for example, LED lights, meters, gauges, screen or monitor of a computing device, tablet, and/or smartphone.

Additionally, or alternatively, in one or more arrangements, the inputs and/or display may be implemented on a separate device that is communicatively connected to control circuit 102. For example, in one or more arrangements, operation of control circuit 102 may be customized or controlled using a smartphone or other computing device that is communicatively connected to the control circuit 102 (e.g., via Bluetooth, WIFI, and/or the internet).

### Control Processes 134:

In one or more arrangements, software code 116 is configured to implement one of more control processes 134 that cause processing circuit 112 of control circuit 102 to monitor sensors data received from smart tags 12 and/or sensors 106 and perform various preprogramed actions in response to data received from smart tags 12 satisfying one or more trigger conditions.

For instance, in one or more arrangements, control processes 134 may configure processing circuit 112 of control circuit 102 to perform the following steps: 1) acquire sensor data from one or more smart tags 12 and/or sensors 106; 2) determine if any trigger conditions in configuration data file 118 are satisfied by the sensor data; and 3) if a trigger condition is satisfied, perform the operation(s) specified for the trigger condition in the configuration data file 118.

Configuration data file 118 is any form of information that indicates conditions in which control circuit 102 is to perform actions in response to sensor data and which actions are to be performed. In the arrangement shown, configuration data file 118 is configured and arranged as a set of rules, where each rule indicates a set of conditions and one or more actions to be performed when the conditions are satisfied. However, it is contemplated that control circuit 102 may be configured to utilize a configuration data file 18 with any configuration, arrangement, format, or structure. In some various arrangements, actions may include but are not limited to, transmitting commands to one or more other systems utilized in the livestock operation (e.g., an environmental control system 124, a feed dispensing system 126, water dispensing system 130, providing status messages, alerts and/or sensor data to one or more users and/or devices 128 (e.g., computer, table, or smartphone), sending notifications to users (e.g., emails, SMS, push notifications, automated phone call, social media messaging, and/or any other type of messaging) regarding operation of system 10 and/or management of livestock.

### Analytics Processes 136:

In one or more arrangements, software code 116 is configured to implement one or more analytics processes 136 configured to perform analytics on sensor data received from smart tags 12 to derive additional data metrics pertinent to animal husbandry.

For example, in one or more arrangements, analytics processes 136 may be configured to evaluate the sensor data using one or more classifiers or state machines that are trained to identify when animals 16 are engaged in various activities. In one or more arrangements, such activities may include but are not limited to, for example, lying in a prone position, kneeling, standing, walking, running, sleeping, eating, drinking, and/or any other activity.

As another example, in one or more arrangements, analytics processes 136 may be additionally or alternatively be configured to evaluate the sensor data using one or more classifiers or state machines that are trained to identify when an animal 16 may have an illness or other health issue. For example, in one or more arrangements, analytics processes 136 may configured to determine if an animal 16 has a fever by receiving an animal reference temperature from one of the sensors 24 and comparing the measurement to a threshold temperature (e.g., 105° F.). If the temperature measurement exceeds the threshold temperature, the animal 16 is determined to be exhibiting a fever. In one or more arrangements, control processes 134 may be configured to send an alert message to an animal caretaker in response to detecting the fever so the animal 16 may be isolated to facilitate treatment and prevent the spread of possible illness.

It is recognized that the animal reference temperature at which animals 16 exhibit fever may vary depending on the illness, environmental temperature, and individual animal 16. In one or more arrangements, analytics processes 136 may configured to determine if an animal 16 has a fever by comparing an animal reference temperature measurement of the animal 16 to a baseline animal reference temperature exhibited by the animal 16 previously. As one example, baseline animal reference temperature may be an average animal reference temperature of the animal 16 during a previous observation period (e.g., 10 preceding days). If the measured animal reference temperature of the animal 16 exceeds the baseline animal reference temperature by a specified threshold amount (e.g., 3° F.), the animal 16 may be determined to be exhibiting a fever.

In one or more arrangements, analytics processes 136 may be additionally or alternatively be configured to compile and analyze sensor data to evaluate a health rating of each animal 16 (e.g., based on temperature, level of activity, eating and drinking, and/or other data metrics indicated by and/or derived from the sensor data). For example, in one or more arrangements, analytics processes 136 may determine health ratings using one or more classifiers or state machines that are trained to quantify health of an animal from the sensor data. In some arrangements, analytics processes 136 is configured to track the health rating of each animal over time and identify deviations in the health rating of an animal 16 from the average/typical health rating of the animal 16. In one or more arrangements, analytics processes 136 are configured to perform data analytics to identify deviations from the average/typical readings in the health rating of other animals 16.

As another example, in one or more arrangements, analytics processes 136 may be additionally or alternatively be configured to evaluate the sensor data using one or more classifiers or state machines that are trained to identify environmental conditions and/or other external events that may pose harm to animals 16. For instance, in one or more arrangements, analytics processes 136 may be configured to monitor measurements of ambient environmental temperature to detect instances when animals 16 are exposed to potentially dangerous environmental conditions (e.g., resulting from heat wave, cold snap, or failure of environmental control equipment.

As yet another example, in one or more arrangements, analytics processes 136 may be additionally or alternatively be configured to evaluate the sensor data to identify deviations that may be of concern. For instance, in one or more arrangements, analytics processes 136 may be configured to identify when sensor data measurements for an animal 16 deviates from typical sensor data measurements previously received for the animal. Additionally or alternatively, in one or more arrangements, analytics processes 136 may be configured to identify when sensor data measurements for an animal 16 deviates from sensor data measurements of other similarly situated animals.

### Analytics Processes 136 on Smart Tag 12:

While some arrangements may be primarily illustrated and/or described with reference to performance of analytics processes 136 on control system 14 or in the cloud, the contemplated arrangements are not so limited. Rather, it is envisioned that in some various arrangements, analytics processes 136 may additionally or alternatively be performed on smart tag 12. For example, in one or more arrangements, electronic circuit 26 on smart tag 12 may be configured to perform one or more analytics processes 136 on data from sensors to identify activities that the animal is engaged in (e.g., lying in a prone position, kneeling, standing, walking, running, sleeping, eating, drinking, and/or any other activity) and/or determine health rating of the animal. For instance, in one or more arrangements, electronic circuit 26 may be programed with a set of trained classifiers that are configured to determine current activity, health rating, or other category or data metric based on the sensor data.

In one or more arrangements, classifiers are configured to determine current activity of the animal based on motion data gathered by an accelerometer, a gyroscopic sensor, and/or compass (e.g., on a 9 axis accelerometer). For instance, in one or more arrangements, accelerometer data of x, y, and z axes are root mean squared and combined to determine an acceleration vector. The classifiers may use the acceleration vector along with orientation data (e.g., pitch, roll, yaw, and/or direction) indicated by a gyroscopic sensor, and/or compass to identify motions correlated with various activities.

Various different arrangements may sample data from sensors, perform analytics on the data, and communicate analytics results to control system 14 at various different frequencies. As one illustrative example, data is sampled from sensor at a frequency of 25 hz, analytics processes categorize activity (or other data metric) from the sensor data every minute, and analytics results are communicated control system every half hour. However, smart tags 12 may be configure to sample, analyze, and/or communicate data at any other frequency.

Additionally or alternatively, in some various arrangements, may be configured to communicate data to control system in response to occurrence of particular events. For instance, in one or more arrangements, smart tags 12 may be configured to communicate data to control system 14 in response to sensor data and/or derived data metrics satisfying a particular set of criteria. For example, in one or more arrangements, smart tags 12 may communicate data in response to one or more classifiers detecting a condition indicating an animal may be in immediate danger.

### Machine Learning:

In one or more embodiments, analytics processes 136 and/or other processes and/or components of system 10 may be configured and arranged to monitor, learn, and modify one or more features, functions, and/or operations of the system. For instance, analytics processes 136 may be configured to monitor and/or analyze sensor data and/or operation of system 10. As one example, in one or more arrangements, analytics processes 136 may be configured to analyze the sensor data and learn, over time, data metrics indicative of particular events and/or automated operation of system 10 that is optimal for the production of livestock. Such learning may include, for example, generation and training of classifiers and/or state machines configured to map input data values to outcomes of interest or to operations to be performed by the system 10. Such trained classifiers and/or state machines may then be utilized to implement analytics processes 136 performed on smart tags 12 (e.g., to identify animal behavior and/or other notable data metrics).

In some various embodiments, analysis by the analytics processes 136 may include various guided and/or unguided artificial intelligence and/or machine learning techniques including, but not limited to: neural networks, genetic algorithms, support vector machines, k-means, kernel regression, discriminant analysis and/or various combinations thereof. In different implementations, analysis may be performed locally, remotely, or a combination thereof.

In some various embodiments, smart tags 12 may be selectably configured to operate in a training mode, where detailed sensor data (e.g., raw sensor data) is communicated to control system 14 to facilitate further training of classifiers (or performance of other analytics processes 136), an operation mode where smart tags 12 communicates summarized sensor data and/or data metrics derived therefrom (e.g., detected livestock behavior) to control system 14. As an illustrative example, in one or more arrangements, control system 14 may be configured to wirelessly prompt smart tags to transition into training mode. In one or more arrangements, when smart tags 12 are in training mode, control system 14 receives raw motion data (e.g., from accelerometer and gyroscopic sensors of smart tags 12) along with video monitoring livestock from the same time period. On control system 14, analytics processes 136 sync the motion data and video and evaluate using machine learning to train classifiers to identify patterns of motion data correlated with various livestock behaviors. In one or more arrangements, after training of classifiers, control system 14 may be configured to wirelessly push trained classifiers to smart tags 12 and then place smart tags 12 in operation mode. Smart tags then utilized the updated trained classifiers to analyze sensor data during operation.

From the above discussion it will be appreciated that the system presented herein improves upon the state of the art. More specifically, and without limitation, it will be appreciated that in one or more arrangements, a livestock monitoring system is presented: that improves upon the state of the art, that uses a tag having sensors for monitoring of livestock, that includes a tag configured to communicate sensor data to a control system, that performs analytics on data gathered by sensors in a tag, that is less susceptible to damage, that is easy to attach tags to livestock, that can be reused for multiple animals, that is durable, that has a robust design, and/or that is high quality.

Example embodiments of the invention have been described in an illustrative manner. It is to be understood that the terminology that has been used is intended to be in the nature of words of description rather than of limitation. It will be appreciated by those skilled in the art that other various modifications could be made to the device without parting from the spirit and scope of this disclosure. All such modifications and changes fall within the scope of the claims and are intended to be covered thereby.

What is claimed:

1. A tag system for monitoring of livestock, comprising:
a tag;
the tag configured to attach to an animal;
the tag having a set of sensors;
the set of sensors including a first temperature sensor configured to monitor a temperature of the animal;
the set of sensors including a second temperature sensor configured to monitor an ambient temperature of an environment where the animal is located;
the set of sensors including a gyroscopic sensor;
the set of sensors including an accelerometer sensor;
the tag including an electronic circuit;
the electronic circuit configured to communicate data derived from measurements of the set of sensors to a control system communicatively connected to the tag.

2. The system of claim 1, wherein the control system is configured to perform analytics on the data received from the electronic circuit of the tag to determine when the animal is engaging in one or more activities.

3. The system of claim 1, wherein the control system is configured to perform analytics on the data received from the electronic circuit of the tag to determine when the animal is prone, kneeling, standing, eating, drinking, walking, and sleeping.

4. The system of claim 1, wherein the control system is configured to process data received from the electronic circuit of the tag using one or more trained classifiers to identify when the animal is prone, kneeling, standing, eating, drinking, walking, and sleeping.

5. The system of claim 1, wherein the control system is configured to store the data received from the electronic circuit of the tag.

6. The system of claim 1, wherein the control system is configured to identify deviations in biometric data indicated by the data received from the electronic circuit of the tag.

7. The system of claim 1, wherein the control system is configured to identify deviations in the data received from the electronic circuit of the tag from data previously received from the electronic circuit of the tag.

8. The system of claim 1, wherein the control system is configured to identify deviations in the data received from the electronic circuit of the tag of the animal in comparison to data received from a plurality of tags attached to a plurality of other animals.

9. The system of claim 1, wherein the control system is configured to perform one or more actions specified in a data file in response to the data received from the electronic circuit of the tag satisfying a trigger condition specified in the data file.

10. The system of claim 1, wherein the control system is configured to send an alert to a user specified in a data file in response to the data received from the electronic circuit of the tag satisfying a trigger condition specified in the data file.

11. The system of claim 1, wherein the control system is configured to adjust operation of an environmental control system based on data received from the electronic circuit of the tag.

12. The system of claim 1, wherein the control system is configured to adjust operation of a water dispenser based on data received from the electronic circuit of the tag.

13. The system of claim 1, wherein the control system is configured to adjust operation of a feed dispenser based on data received from the electronic circuit of the tag.

14. The system of claim 1, wherein the electronic circuit is configured to perform analytics on the measurements from the set of sensors to determine when the animal is engaging in one or more activities;
wherein the data communicated to the control system indicates the one or more activities engaged in by the animal.

15. The system of claim 1, wherein the tag includes a housing wherein the housing is configured to protect the electronic circuit and the set of sensors.

16. The system of claim 1, wherein the tag includes a housing;
wherein the housing is waterproof.

17. The system of claim 1, wherein the tag includes a housing;
wherein the tag includes a connector;
wherein the housing includes a connection feature configured to facilitate connection with the connector.

18. The system of claim 1, wherein the tag includes a housing;
wherein the tag includes a connector;
wherein the housing includes a connection feature configured to facilitate connection with the connector;
wherein the connection feature is a female type connector and the connector is a male type connector.

19. The system of claim 1, wherein the tag includes a housing;
wherein the tag includes a connector;
wherein the housing includes a connection feature configured to facilitate connection with the connector;
wherein the connection feature is a female type connector and the connector is a male type connector;
wherein a portion of the housing that is positioned proximate to the connection feature has a durometer value in the range of A90-A95.

20. The system of claim 1, wherein the tag includes a housing;
wherein the tag includes a connector;
wherein the housing includes a connection feature configured to facilitate connection with the connector;
wherein the connection feature is a male type connector and the connector is a female type connector.

21. The system of claim 1, wherein the tag includes a housing;
wherein the tag includes a connector;
wherein the housing includes a connection feature configured to facilitate connection with the connector;
wherein the connection feature is a male type connector and the connector is a female type connector;
wherein as least one of the set of sensors is positioned on the male type connector of the connection feature.

22. The system of claim 1, wherein the tag includes a connector;
wherein the connector is configured to attach to the animal by piercing.

23. The system of claim 1, wherein the tag includes a housing;
wherein the housing has sloped surfaces configured to inhibit biting of the housing by animals.

24. The system of claim 1, wherein the tag is configured to be reusable for multiple animals.

25. The system of claim 1, wherein the tag is configured to be reusable for at least three animals.

26. A tag system for monitoring of livestock, comprising:
a plurality of tags;
each of the plurality of tags having a set of sensors;
the set of sensors including a first temperature sensor configured to monitor a temperature of an animal to which the tag is attached;
the set of sensors including a second temperature sensor configured to monitor a temperature of an environment where the animal is located;
the set of sensors including a gyroscopic sensor;
the set of sensors including an accelerometer sensor;
a control system;
the control system communicatively connected to the plurality of tag;
the control system configured to receive sensor data from the plurality of tags.

27. The system of claim 26, wherein the control system is configured to perform analytics on the sensor data received from the plurality of tags to determine when animals wearing the plurality of tags are engaging in one or more activities.

28. The system of claim 26, wherein the control system is configured to perform analytics on the sensor data received from the plurality of tags to determine when the animal is prone, kneeling, standing, eating, drinking, walking, and sleeping.

29. The system of claim 26, wherein the control system is configured to store the sensor data received from the plurality of tags.

30. The system of claim 26, wherein the control system is configured to identify deviations in biometric data indicated by the sensor data received from the plurality of tags.

31. The system of claim 26, wherein the control system is configured to perform one or more actions specified in a data file in response to the sensor data received from the plurality of tags satisfying a trigger condition specified in the data file.

32. The system of claim 26, wherein the control system is configured to send an alert to a user specified in a data file in response to the sensor data received from the plurality of tags satisfying a trigger condition specified in the data file.

33. The system of claim 26, wherein the control system is configured to adjust operation of an environmental control system based on sensor data received from the plurality of tags.

34. The system of claim 26, wherein the control system is configured to adjust operation of a water dispenser based on sensor data received from the plurality of tags.

35. The system of claim 26, wherein the control system is configured to adjust operation of a feed dispenser based on the sensor data received from the plurality of tags.

36. A tag system for monitoring of livestock, comprising:
a tag;
the tag configured to attach to an animal;
the tag having a set of sensors;
the set of sensors including a first temperature sensor configured to monitor a temperature of an animal to which the tag is attached;
the set of sensors including a second temperature sensor configured to monitor a temperature of an environment where the animal is located;
the set of sensors including a gyroscopic sensor;
the set of sensors including an accelerometer sensor;
the tag having an electronic circuit configured to receive sensor data from the plurality of tags;
the electronic circuit configured to perform analytics on the sensor data to derive one or more data metrics;
a control system;
the control system communicatively connected to the tag;
the control system configured to receive the data metrics from the plurality of tags;
the control system configured to perform analytics to determine a health rating of the animal based on the sensor data.

37. The system of claim 36, the control system configured to receive at least some of the sensor data from the plurality of tags;

38. The system of claim 36, wherein the data metrics indicate one or more activities engaged in by the animal.

39. The system of claim 36, wherein the data metrics indicate a health status of the animal.
